(19) United States
(12) Patent Application Publication
(10) Pub. No.: US 2010/0181979 A1
(43) Pub. Date: Jul. 22, 2010

(54) DC/DC converter circuit

(75) Inventors: Junichi Abe, Kanagawa (JP); Yutaka Yamagami, Kanagawa (JP); Hisashi Mori, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/654,874

(22) Filed: Jan. 7, 2010

(30) Foreign Application Priority Data
Jan. 20, 2009 (JP) 2009-009490

(51) Int. Cl. G05F 1/10

(52) U.S. Cl. 323/282

(57) ABSTRACT

A DC/DC converter circuit including a boosting circuit which includes: a first capacitance (FC); a first switch (FS), one end of FS connected to a first terminal of FC, and another end of FS connected to a first power supply; a second switch (SS), one end of SS connected to a second terminal of FC, and another end of SS connected to a second power supply; a third switch (TS), one end of TS connected to the first terminal of FC, and another end of TS connected to an output terminal; an amplifier, an output of the amplifier electrically connected to the second terminal of FC; and a voltage-dividing resistor that generates a feedback voltage to be provided to amplifier, and connected to the first terminal of FC.

### BACKGROUND

1. Field of the Invention

The present invention relates to a DC/DC converter circuit, in particular a DC/DC converter circuit including a charge-pump circuit and a differential amplifier.

2. Description of Related Art

Mobile devices such as mobile phones, PDAs (Personal Digital Assistants), and digital cameras (DSCs: Digital Still Cameras) use a DC/DC converter to generate a voltage of about 5 V, which is required to drive a liquid crystal display, from a power-supply voltage of about 3 V. In mobile devices, reduction in size and power consumption has been advancing, and thus reduction in the number of peripheral components and in power consumption has been also advancing in DC/DC converter circuits.

Incidentally, the increase in the number of display colors of liquid crystal displays is remarkable in recent years, and in response to this, the number of display grayscale levels has been also increasing. In liquid crystal driving circuits, it is necessary to generate drive voltages according to corresponding grayscale levels, and thus to narrow the voltage intervals between neighboring grayscale levels. Specifically, DC/DC converter circuits for generating a voltage with accuracy in the order of several tens of mV, for example, are required.

There are various modes in DC/DC converter circuits. Among them, charge-pump circuits have been used in mobile devices in many cases because they require smaller total volume for the components. However, charge pump circuits cause ripples in their output voltage, and therefore they have a problem in terms of stability of the output voltage.

To solve this problem, stabilized power supply circuits using differential amplifiers can be used (for example, Japanese Unexamined Patent Application Publication No. 2002-171748). In a differential amplifier, a predetermined reference voltage is supplied to the non-inverting input terminal and the inverting input terminal is connected to a feedback point, on which the output voltage of the differential amplifier acts. Therefore, it works such that the voltage at the feedback point becomes equal to the reference voltage. Note that since the differential amplifier functions only to maintain the voltage at the feedback point equal to a predetermined reference voltage, the range of the output voltage and the like are dependent on the design conditions. Further, the stabilized power supply circuit can output a voltage that is completely different from the power supply range of the differential amplifier by using means to produce a potential difference, such as a battery or a capacitance, between the output of the stabilized power supply circuit and the output of the differential amplifier.

FIG. 8 is a circuit diagram of a DC/DC converter in the related art. This DC/DC converter circuit includes a charge-pump circuit 4 and a differential amplifier 1. The charge-pump circuit 4 includes a capacitance C1, and switches SW1 to SW4 that are used to charge and discharge the capacitance C1. The differential amplifier 1 uses a connection point between resistors R1 and R2 constituting a voltage-dividing resistor 2 as a feedback point, and compares a voltage V_{D} at the feedback point with a reference voltage V_{REF} to control an amplifier output voltage V_{AMP}. The resistors R1 and R2 are connected in series between an output terminal OUT, from which an output voltage V_{OUT} is output, and a ground GND.

In the charge-pump circuit 4, the switches SW1 and SW2, and the switches SW3 and SW4 operate in a complementary manner. When the switches SW1 and SW2 are in an on-state and the switches SW3 and SW4 are in an off-state, the capacitance C1 is charged with an electrical charge corresponding to the power-supply voltage V_{DD}. Next, when the switches SW1 and SW2 are turned off and the switches SW3 and SW4 are turned on, a voltage that was raised based on the electrical charge charged in the capacitance C1 is output to the output terminal OUT. At this point, the output from the differential amplifier 1 returns to the inverting input terminal of the differential amplifier 1 through the switch SW4, the capacitance C1, the switch SW3, and the voltage-dividing resistor 2. That is, a negative feedback circuit is formed, and the output voltage V_{OUT} is thereby maintained as shown by the following equation (1).

V_{OUT}=V_{REF}×(R1+R2)/R2 (1)

More detailed explanation is made hereinafter. The differential amplifier 1 compares a voltage V_{D} at the feedback point obtained by dividing the output voltage V_{OUT} by the voltage-dividing resistor 2 with the reference voltage V_{REF} to control the amplifier output voltage V_{AMP}. When the switches SW1 and SW2 are in an off-state and the switches SW3 and SW4 are in an on-state, the output terminal of the differential amplifier 1 is connected to the low potential side terminal of the capacitance C1 through the switch SW4, and the low potential side potential V1 of the capacitance C1 thereby becomes equal to the amplifier output voltage V_{AMP}. Meanwhile, the high potential side potential V2 of the capacitance C1 becomes higher than the low potential side potential V1 of the capacitance C1 by an amount equivalent to the charging voltage. Further, since the high potential side terminal of the capacitance C1 is connected to the output terminal OUT through the switch SW3, the output voltage V_{OUT} becomes equal to the high potential side potential V2 of the capacitance C1. Since the output terminal OUT is also connected to the voltage-dividing resistor 2, the output voltage V_{OUT} is fed back to the differential amplifier 1. Therefore, even if consumption is caused by a load 3, or even if it is interfered by noise or the like, the output voltage V_{OUT} is fixed as shown by the equation (1).

However, in the DC/DC converter circuit shown in FIG. 8, an overshoot, i.e., a phenomenon in which an actual voltage temporarily exceeds the target voltage, occurs in the high potential side potential V2 of the capacitance C1 as described below in detail. Therefore, it is necessary to design the withstand voltages of components of the LSI while taking such overshoots into account, and thus posing a problem that the manufacturing costs increase due to increase in the size of the LSI, changes in the manufacturing process, and so on. Further, there are other problems that the output voltage V_{OUT} falls due to the load 3 and that ripples thereby occur in the output voltage.

Detailed explanation is made hereinafter with reference to FIG. 9. When the switches SW1 and SW2 of the charge-pump circuit 4 are in an off-state and the switches SW3 and SW4 are in an on-state, the load 3 consumes the electrical charge charged in the capacitance C1 through the switch SW3. However, the differential amplifier 1 raises the low potential side potential V1 of the capacitance C1 through the feedback action. Therefore, the output voltage V_{OUT} is maintained as shown by the equation (1).

Letting I_{L} be the current flowing through the load 3, the rise voltage ΔV1 in the low potential side potential V1 for each time period T1 is expressed by the following equation (2).

ΔV1=I_{L}×T1/C1 (2)

Immediately after it is switched to the feedback action state by the differential amplifier 1, the change in the output voltage V_{OUT} is delayed from the change in the high potential side potential V2 of the capacitance C1 due to the effect of the parasitic resistance of the switch SW3. Therefore, the differential amplifier 1 causes a response delay, and therefore there is a possibility that the output voltage V_{AMP} of the differential amplifier 1 temporarily rises to the power-supply voltage V_{DD}. Then, the high potential side potential V2 of the capacitance C1 rises to 2×V_{DD} at the maximum, and the maximum amplitude voltage ΔV of an overshoot in the high potential side potential V2 of the capacitance C1 is thereby expressed by the following equation (3) by using the equation (1).

ΔV=2×V_{DD}−V_{OUT}=2×V_{DD}−(V_{REF}×(R1+R2)/R2) (3)

FIG. 10 is a waveform chart of a boosting action of a DC/DC converter circuit shown in FIG. 8. As described above, when shifting from the charging period to the boosting period, the change in the output voltage V_{OUT} is delayed with respect to the high potential side potential V2 of the capacitance C1. Since the voltage-dividing resistor 2 is connected to the output terminal OUT and does not include any delay element, the change in the voltage V_{D} at the feedback point follows the change in the output voltage V_{OUT}. Therefore, a delay occurs from the high potential side terminal of the capacitance C1 to the feedback point of the voltage-dividing resistor 2, and the response delay of the differential amplifier 1 thereby becomes larger. As a result, an overshoot occurs in the high potential side potential V2 of the capacitance C1 as indicated by the waveform shown in FIG. 9. For example, assuming that the power-supply voltage of the differential amplifier 1 is V_{DD}, the high potential side potential V2 of the capacitance C1 exceeds the target voltage and rises to 2×V_{DD}.

Next, when the switches SW1 and SW2 of the charge-pump circuit 4 are in an on-state and the switches SW3 and SW4 are in an off-state, the capacitance C1 is charged with an electrical charge corresponding to the power-supply voltage V_{DD}. In this case, the negative feedback path by the differential amplifier 1 is being disconnected. Further, since no electrical charge is discharged from the capacitance C1, the load 3 connected to the output terminal OUT consumes only the electrical charge charged in the capacitance C2. Therefore, the output voltage V_{OUT} falls. That is, a ripple occurs. Letting I_{L} be the current flowing through the load 3, the drop voltage ΔV2 by the ripple in the output voltage V_{OUT} for each time period T2 is expressed by the following equation (4).

ΔV2=I_{L}×T2/C2 (4)

### SUMMARY

As has been described above, the circuit configuration disclosed in Japanese Unexamined Patent Application Publication No. 2002-171748 has a problem that an overshoot occurs in the high potential side potential of the capacitance. Further, there are other problems that the output voltage falls and that ripples thereby occur in the output voltage.

A first exemplary aspect of the present invention is a DC/DC converter circuit including a boosting circuit, the boosting circuit including: a first capacitance; a first switch, one end of the first switch being connected to a first terminal of the first capacitance, and another end of the first switch being connected to a first power supply; a second switch, one end of the second switch being connected to a second terminal of the first capacitance, and another end of the second switch being connected to a second power supply; a third switch, one end of the third switch being connected to the first terminal of the first capacitance, and another end of the third switch being connected to an output terminal; an amplifier, an output of the amplifier being electrically connected to the second terminal of the first capacitance; and a voltage-dividing resistor that generates a feedback voltage to be provided to the amplifier, the voltage-dividing resistor being connected to the first terminal of the first capacitance.

In an exemplary aspect, the present invention can provide a DC/DC converter circuit capable of suppressing an overshoot in the high potential side potential of the capacitance.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a circuit diagram of a DC/DC converter circuit in accordance with a first exemplary embodiment of the present invention;

FIG. 2 is a waveform chart of a DC/DC converter circuit shown in FIG. 1;

FIG. 3 is a waveform chart of a boosting action of a DC/DC converter circuit shown in FIG. 1;

FIG. 4 is a circuit diagram of a DC/DC converter circuit in accordance with a second exemplary embodiment of the present invention;

FIG. 5 is an example of a differential amplifier circuit in FIG. 4;

FIG. 6 is a waveform chart of a DC/DC converter circuit shown in FIG. 4;

FIG. 7 is a circuit diagram of a DC/DC converter circuit in accordance with a third exemplary embodiment of the present invention;

FIG. 8 is a circuit diagram of a DC/DC converter circuit in the related art;

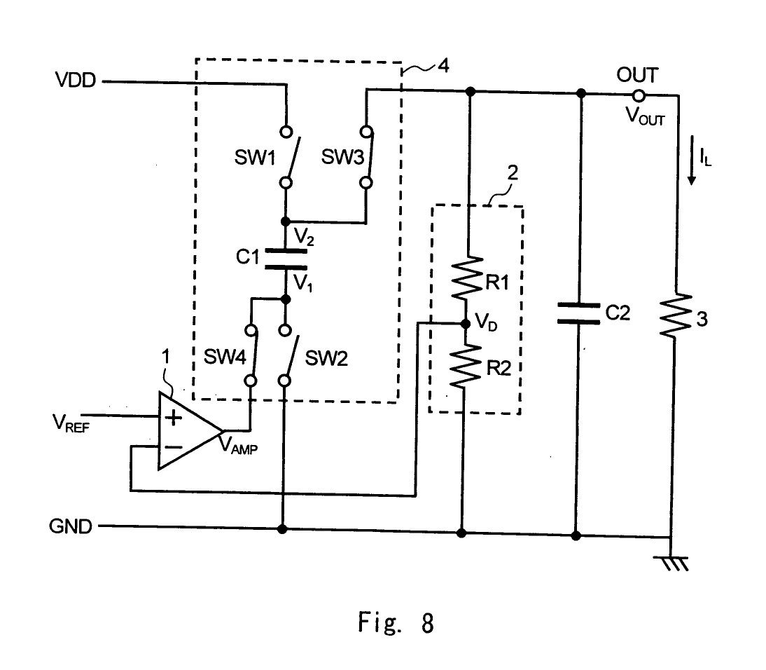

FIG. 9 is a waveform chart of a DC/DC converter circuit shown in FIG. 8; and

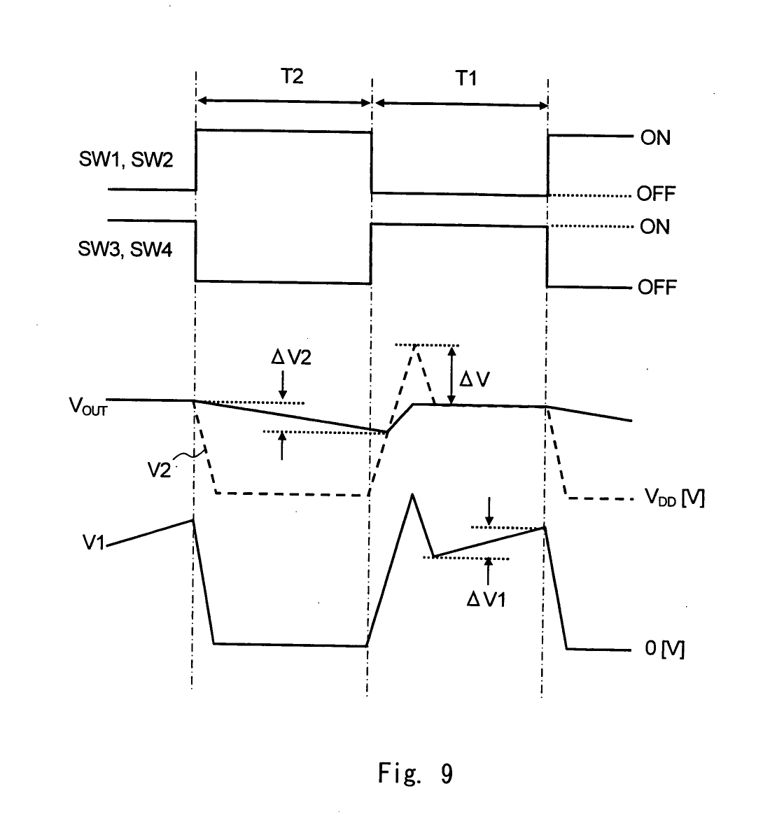

FIG. 10 is a waveform chart of a boosting action of a DC/DC converter circuit shown in FIG. 8.

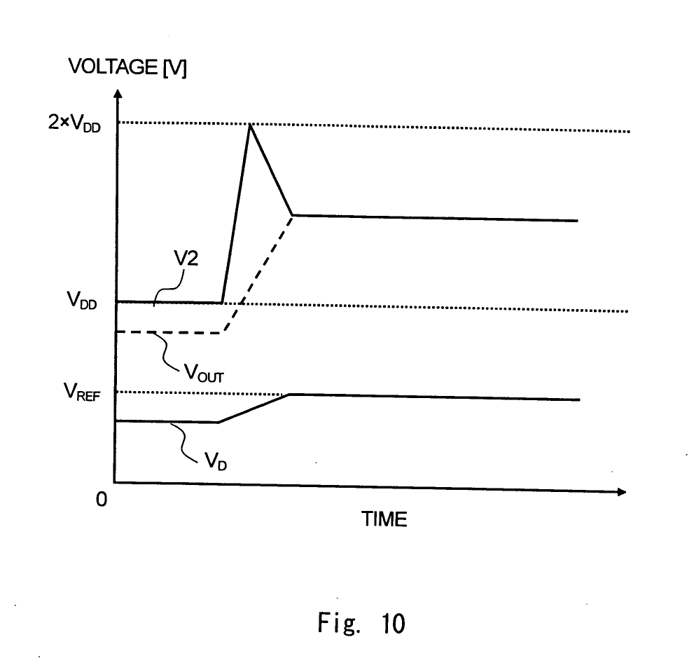

### DETAILED DESCRIPTION OF THE EXEMPLARY EMBODIMENTS

Exemplary embodiments of the present invention are explained hereinafter. However, the present invention is not limited to the exemplary embodiments shown below. Further, the following description and the drawings may be partially simplified as appropriate for clarifying the explanation.

### First Exemplary Embodiment

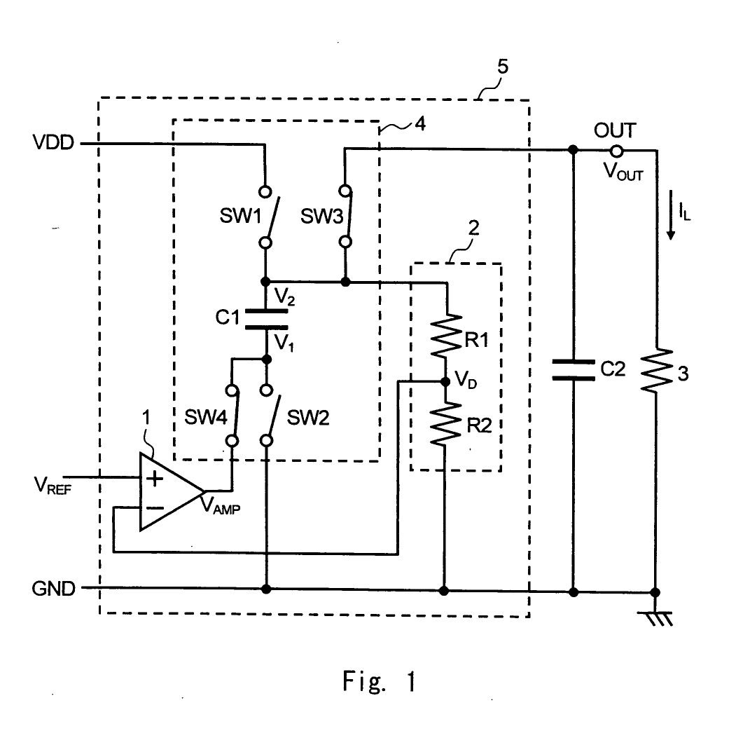

Exemplary embodiments of the present invention are explained hereinafter with reference to the drawings. FIG. 1 is a circuit diagram of a DC/DC converter circuit in accordance with a first exemplary embodiment of the present invention. The DC/DC converter circuit shown in FIG. 1 includes a charge-pump circuit 4, a booster circuit 5 including a differential amplifier 1 and a voltage-dividing resistor 2, and a capacitor C2 for smoothing that is connected in parallel with the booster circuit 5.

The charge-pump circuit 4 includes a capacitance C1, and switches SW1 to SW4 that select charging or discharging for the capacitance C1. Specifically, the low potential side terminal of the capacitance C1 is connected to one ends of switches SW2 and SW4 that are connected in parallel. The other end of the switch SW2 is connected to a ground GND, and the other end of the switch SW4 is connected to the output terminal of the differential amplifier 1. Meanwhile, the high potential side terminal of the capacitance C1 is connected to one ends of switches SW1 and SW3 that are connected in parallel. The other end of the switch SW1 is connected to a power supply V_{DD}, and the other end of the switch SW3 is connected to the output terminal OUT.

The non-inverting input terminal of the differential amplifier 1 is connected to a reference voltage V_{REF}. The inverting input terminal of the differential amplifier 1 is connected to a connection point between resistors R1 and R2 connected in series, which serves as a feedback point. As described above, the output terminal of the differential amplifier 1 is connected to the capacitance C1 through the switch SW4. Further, the high potential side terminal of the capacitance C1 is connected to the resistor R1 without interposing the switch SW3 therebetween. In other words, the voltage-dividing resistor 2, which is composed of the resistors R1 and R2, is connected in parallel with the capacitance C1 with respect to the switch SW3. The differential amplifier 1 compares a voltage V_{D} at the feedback point that is generated by the voltage-dividing resistor 2 with the reference voltage V_{REF} to control an amplifier output voltage V_{AMP}.

The resistors R1 and R2, which constitute the voltage-dividing resistor 2, are connected in series between the output terminal OUT and the ground GND. Specifically, the other end of the resistor R1 is connected to the output terminal OUT through the switch SW3. Meanwhile, the other end of the resistor R2 is connected to the ground GND.

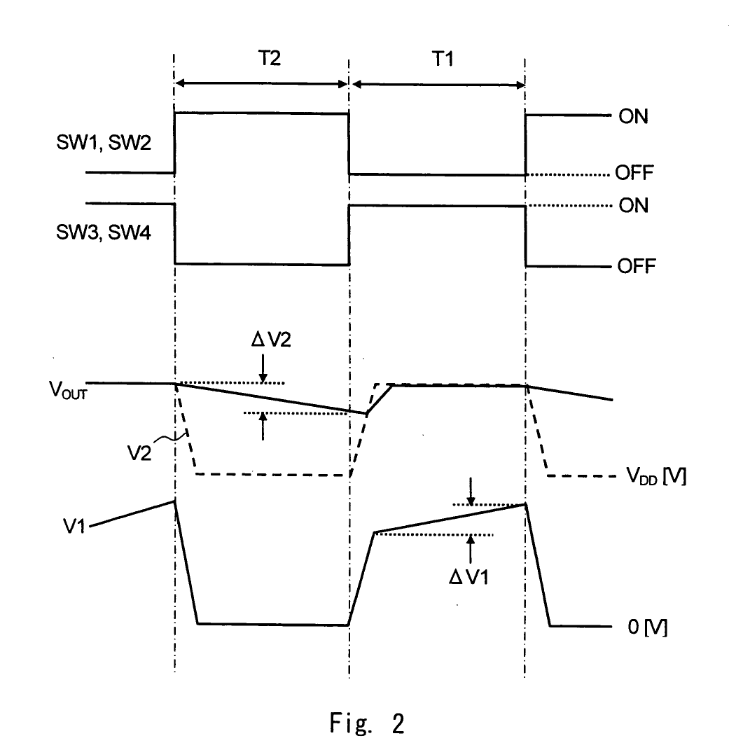

FIG. 2 is a waveform chart of a DC/DC converter circuit shown in FIG. 1. In the charge-pump circuit 4, the switches SW1 and SW2, and the switches SW3 and SW4 operate in a complementary manner. In this way, the charging of the capacitance C1 and the boosting of the capacitance C1 are alternately performed.

Firstly, an operation during a charging period (time T2 in FIG. 2) is explained hereinafter. When the switches SW1 and SW2 of the charge-pump circuit 4 are in an on-state and the switches SW3 and SW4 are in an off-state, the capacitance C1 is charged with an electrical charge corresponding to the power-supply voltage V_{DD}. At this point, the negative feedback path by the differential amplifier 1 is being disconnected. Further, since no electrical charge is discharged from the capacitance C1, the load 3 connected to the output terminal OUT consumes only the electrical charge charged in the capacitance C2. Therefore, the output voltage V_{OUT} falls. Letting I_{L} be the current flowing through the load 3, the drop voltage ΔV2 for each time period T2 is expressed by the following equation (5).

ΔV2=I_{L}×T2/C2 (5)

Next, an operation during a boosting period (time T1 in FIG. 2) is explained hereinafter. When the switches SW1 and SW2 of the charge-pump circuit 4 are in an off-state and the switches SW3 and SW4 are in an on-state, the output from the differential amplifier 1 returns to the inverting input terminal of the differential amplifier 1 through the switch SW4, the capacitance C1, and the voltage-dividing resistor 2. That is, since a negative feedback circuit is formed, a potential V2 at the high potential side terminal of the capacitance C1 connected to the voltage-dividing resistor 2 is raised to a voltage expressed by the following equation (6) and maintained at that voltage.

V2=V_{REF}×(R1+R2)/R2 (6)

Note that in a state where the high potential side potential V2 of the capacitance C1 is maintained at a fixed value, the output voltage V_{OUT} is equal to the high potential side potential V2 of the capacitance C1. Meanwhile, the low potential side potential V1 of the capacitance C1 rises during the time T1. Here, the load 3 consumes an electrical charge charged in the capacitance C1 through the switch SW3. However, it has no effect on the high potential side potential V2 of the capacitance C1. Therefore the high potential side potential V2 is thereby maintained at a fixed value shown by the equation (6). Letting I_{L} be the current flowing through the load 3, the rise voltage ΔV1 in the low potential side potential V1 of the capacitance C1 for each time period T1 is expressed by the following equation (7).

ΔV1=I_{L}×T1/C1 (7)

Note that when shifting from the charging period to the boosting period, no delay is caused from the high potential side terminal of the capacitance C1 to the feedback point of the voltage-dividing resistor 2, and the response delay of the differential amplifier 1 is thereby very small. Therefore, no overshoot in which the high potential side potential V2 of the capacitance C1 exceeds the target voltage occurs.

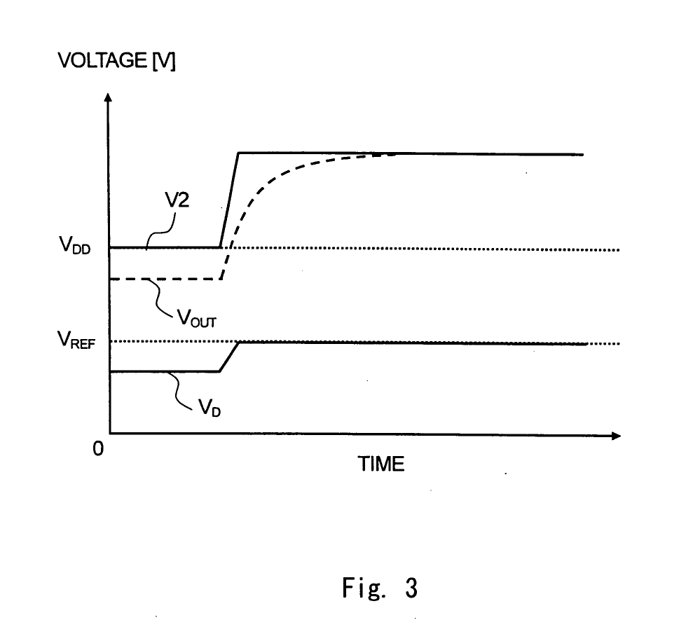

An operation during a transitional period immediately after the boosting by the DC/DC converter circuit shown in FIG. 1 has started is explained hereinafter with reference to a waveform chart shown in FIG. 3. FIG. 3 is a waveform chart of a boosting action of a DC/DC converter circuit shown in FIG. 1. In a DC/DC converter circuit in accordance with an exemplary aspect of the present invention, the voltage-dividing resistor 2 is directly connected to the high potential side terminal of the capacitance C1. Therefore, when shifting from the charging period to the boosting period, no delay due to the parasitic resistance of the switch SW3 and the time constant of the capacitance C2 occurs at the high potential side terminal of the capacitance C1. That is, a voltage V_{D} at the feedback point of the voltage-dividing resistor 2 follows the change in the high potential side potential V2 of the capacitance C1. Further, since substantially no delay is caused throughout the feedback path of the differential amplifier 1, excellent response characteristics can be achieved. Therefore, as shown in FIG. 3, it is possible to prevent an overshoot from occurring in the high potential side potential V2 of the capacitance C1.

Note that although a case where the power supply V_{DD} has a positive potential with respect to the ground GND has been explained, the power supply V_{DD} may have a negative potential with respect to the ground GND.

### Second Exemplary Embodiment

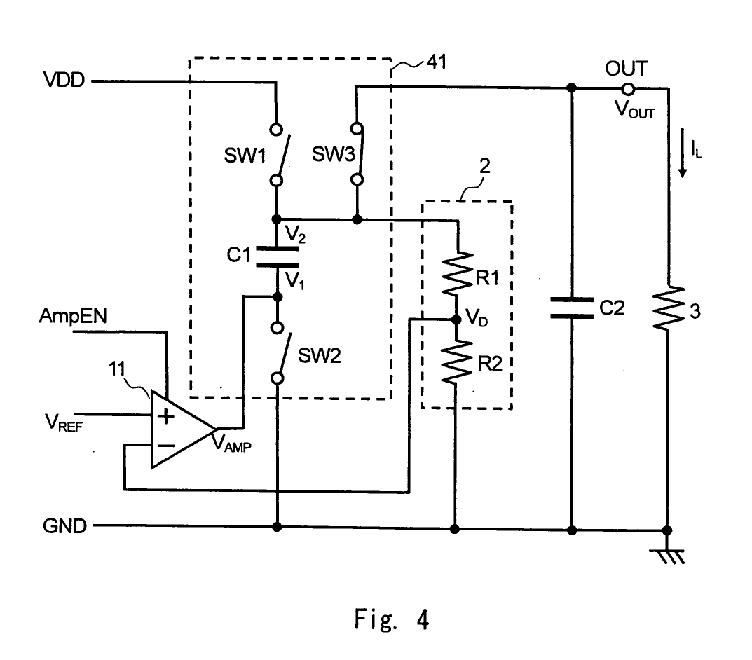

Next, another exemplary embodiment of the present invention is explained hereinafter. FIG. 4 is a circuit diagram of a DC/DC converter circuit in accordance with a second exemplary embodiment of the present invention. The same signs are assigned to the same circuit components as those of the first exemplary embodiment, and their explanation may be omitted as appropriate.

A differential amplifier 11 of a DC/DC converter circuit shown in FIG. 4 can be controlled such that its output state becomes a floating state. The output is connected to the low potential side terminal of the capacitance C1 without interposing any switch of the charge-pump circuit 41 therebetween. Further, the output state is controlled to take one of two states, i.e., a floating state and a driving state by a control signal AmpEN. Further, the switches SW1 and SW2, and the switch SW3 and the signal AmpEN operate in a complementary manner, and by doing so, charging actions and boosting actions for the capacitance C1 are alternately performed.

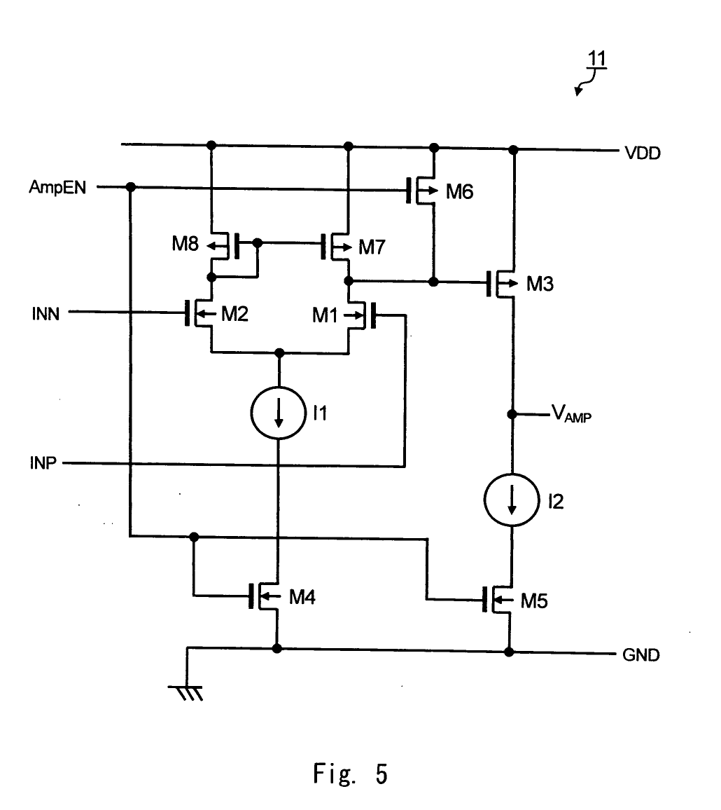

FIG. 5 is an example circuit of the differential amplifier 11 shown in FIG. 4, and it can switch the output of the differential amplifier 11 between a floating state and a driving state by a control signal AmpEN. When the control signal AmpEN at H level is input, the drain potentials of the MOS transistors M1 and M2, for which each input is connected, are determined according to a voltage difference between two differential input terminals INP (non-inverting input terminal) and INN (inverting input terminal). Note that a reference voltage V_{REF} is provided to the INP. Since the drain of the MOS transistor M1 is connected to the gate of the MOS transistor M3 in the output portion, the output voltage V_{AMP} of the differential amplifier 11 is controlled in accordance with the voltage difference between the INP and INN. When the control signal AmpEN at L level is input in the differential amplifier 11, MOS transistors M4 and M5 become an off-state and the current path is thereby disconnected. At the same time, a MOS transistor M6 connected between the gate terminal of the MOS transistor M3 and the power supply V_{DD} becomes an on-state. Therefore, since the MOS transistor M3 becomes an off-state, the output becomes a floating state. Further, MOS transistors M7 and M8 constitute a current mirror as an active load. In the figure, signs I1 and I2 represent constant current sources.

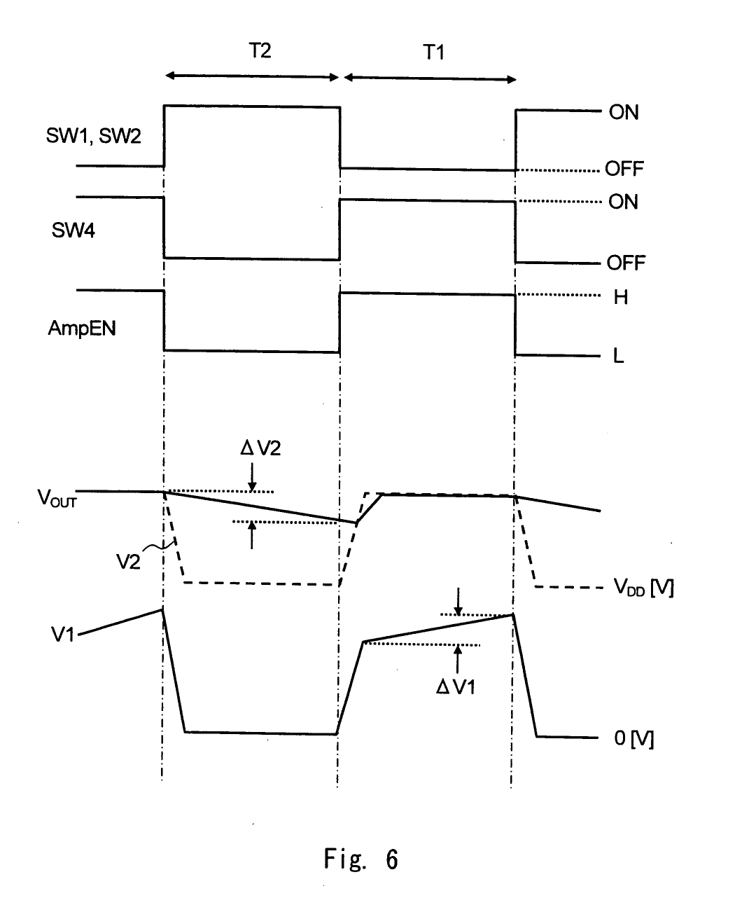

Operations of a DC/DC converter circuit shown in FIG. 4 are explained hereinafter with reference to a waveform chart shown in FIG. 6. Firstly, an operation during a charging period (time T2 in FIG. 6) is explained hereinafter. The output of the differential amplifier 11 is brought into a floating state by turning on switches SW1 and SW2 of the charge-pump circuit 41, turning off the switch SW3, and bringing the control signal AmpEN into L level. As a result, the capacitance C1 is charged with an electrical charge corresponding to the power-supply voltage V_{DD}.

Next, an operation during a boosting period (time T1 in FIG. 6) is explained hereinafter. The output of the differential amplifier 11 is brought into a driving state by turning off the switches SW1 and SW2, turning on the switch SW3, and bringing the control signal AmpEN into H level. As a result, the capacitance C1 is boosted.

In a DC/DC converter circuit in accordance with a second exemplary embodiment shown in FIG. 4, the voltage-dividing resistor 2 is also directly connected to the high potential side terminal of the capacitance C1 as in the case of the DC/DC converter circuit in accordance with the first exemplary embodiment shown in FIG. 1. Therefore, a waveform chart in FIG. 6 is similar to that of FIG. 2. That is, it is possible to prevent an overshoot from occurring in the high potential side potential V2 of the capacitance C1.

Further, the DC/DC converter circuit in accordance with a second exemplary embodiment shown in FIG. 4 does not include any switch corresponding to the switch SW4 in the DC/DC converter circuit in accordance with the first exemplary embodiment shown in FIG. 1. Since the switch SW4 requires a low on-resistance, it occupies a large area on the LSI. Therefore, by eliminating this switch, the effect of reducing the chip size becomes larger. Further, since no parasitic resistance due to the switch SW4 exists on the path from the output of the differential amplifier 1 to the capacitance C1 during the boosting action, the boosting efficiency improves.

### Third Exemplary Embodiment

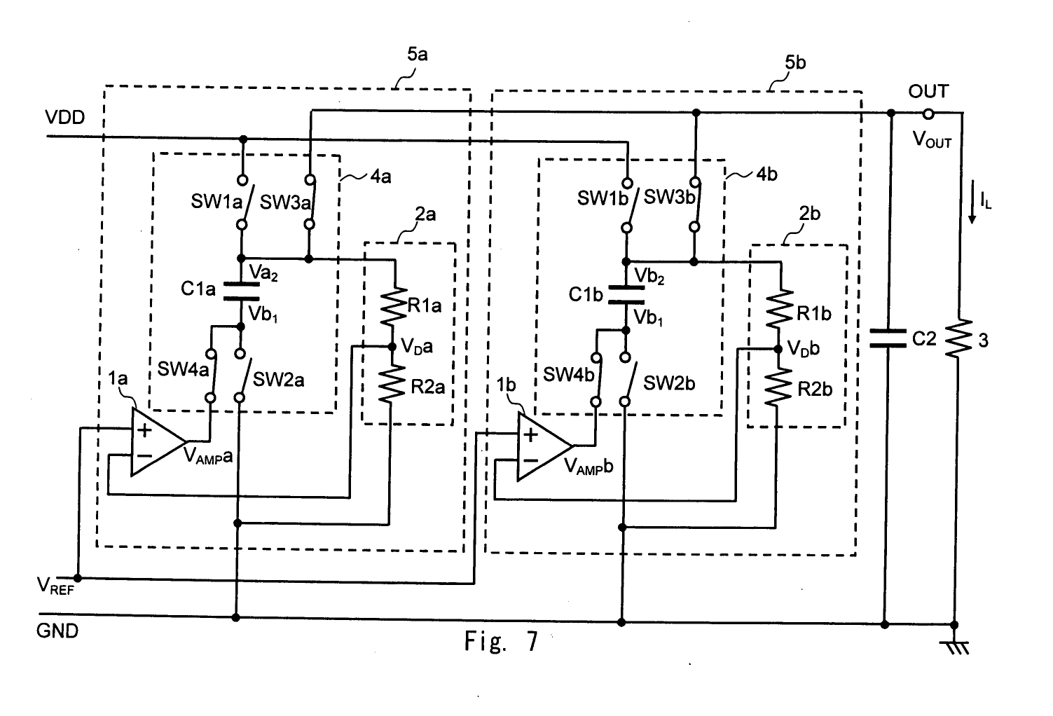

Next, another exemplary embodiment of the present invention is explained hereinafter. FIG. 7 is a circuit diagram of a DC/DC converter circuit in accordance with a third exemplary embodiment of the present invention. The same signs are assigned to the same circuit components as those of the first exemplary embodiment, and their explanation may be omitted as appropriate.

A third exemplary embodiment in accordance with the present invention includes a first boosting circuit 5a, a second boosting circuit 5b, and a capacitance C2 for smoothing. In other words, it has such a configuration that another boosting circuit 5 shown in FIG. 1 is connected in parallel with the DC/DC converter circuit shown in FIG. 1.

The first boosting circuit 5a includes a charge-pump circuit 4a, a differential amplifier 1a, and a voltage-dividing resistor 2a. Note that the charge-pump circuit 4a includes a capacitance C1a and switches SW1a to SW4a. The differential amplifier 1a uses a connection point between resistors R1a and R2a, which constitute the voltage-dividing resistor 2a, as a feedback point, and compares a voltage V_{D}a at the feedback point with a reference voltage V_{REF} to control an amplifier output voltage V_{AMP}a. That is, it has a similar circuit configuration to that of the booster circuit 5 of FIG. 1.

The second boosting circuit 5b includes a charge-pump circuit 4b, a differential amplifier 1b, and a voltage-dividing resistor 2b. Note that the charge-pump circuit 4b includes a capacitance C1b and switches SW1b to SW4b. The differential amplifier 1b uses a connection point between resistors R1b and R2b, which constitute the voltage-dividing resistor 2b, as a feedback point, and compares a voltage V_{D}b at the feedback point with a reference voltage V_{REF} to control an amplifier output voltage V_{AMP}b. That is, it has a similar circuit configuration to that of the booster circuit 5 of FIG. 1. The charge-pump circuit 4a and the charge-pump circuit 4b perform charging actions and boosting actions for their respective capacitances C1a and C1b in a complementary manner. An electrical charge consumed by the load 3 connected to the output terminal OUT is covered by the capacitance of the charge-pump circuit that is performing the boosting action.

Firstly, while the charge-pump circuit 4b is being charged, the charge-pump circuit 4a boosts the voltage. Specifically, when the switches SW1a and SW2a are turned off and the switches SW3a and SW4a are turned on, the electrical charge charged in the capacitance C1a is discharged to the output terminal OUT. At this point, the output of the differential amplifier 1a is returned to the inverting input of the differential amplifier la through the capacitance C1a and the voltage-dividing circuit 2a, and thus forming a negative feedback circuit. Therefore, the high potential side potential V2a of the capacitance C1a connected to the voltage-dividing circuit 2a is maintained at a fixed value. Further, an electrical charge is supplied from the capacitance C1a through the switch SW3a, and the output voltage V_{OUT} is thereby maintained at a fixed value.

Note that the load 3 connected to the output terminal OUT consumes the electrical charge charged in the capacitance C1a through the switch SW3a. However, since the differential amplifier 1a raises the low potential side potential V1a of the capacitance C1a through the feedback action, the output voltage V_{OUT} does not fall.

Next, while the charge-pump circuit 4a is being charged, the charge-pump circuit 4b boosts the voltage. Specifically, when the switches SW1b and SW2b are turned off and the switches SW3b and SW4b are turned on, the electrical charge charged in the capacitance C1b is discharged to the output terminal OUT. At this point, the output of the differential amplifier 1b is returned to the inverting input of the differential amplifier 1b through the capacitance C1b and the voltage-dividing circuit 2b, and thus forming a negative feedback circuit. Therefore, the high potential side potential V2b of the capacitance C1b connected to the voltage-dividing circuit 2b is maintained at a fixed value. Further, an electrical charge is supplied from the capacitance C1b through the switch SW3b, and the output voltage V_{OUT} is thereby maintained at a fixed value.

Note that the load 3 connected to the output terminal OUT consumes the electrical charge charged in the capacitance C1b through the switch SW3b. However, since the differential amplifier 1b raises the low potential side potential V1b of the capacitance C1b through the feedback action, the output voltage V_{OUT} does not fall. That is, the ripple can be reduced.

As has been explained above, either the charge-pump circuit 4a or the charge-pump circuit 4b alternately maintains the output voltage V_{OUT} at a fixed value, and therefore a drop in the output voltage due to the load can be prevented. In this case, the capacitance C2 is not indispensable. Further, by using the differential amplifier 11 shown in the second exemplary embodiment, the switches SW4a and SW4b can be also eliminated.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A DC/DC converter circuit comprising a boosting circuit, the boosting circuit comprising:
a first capacitance;
a first switch, one end of the first switch being connected to a first terminal of the first capacitance, and another end of the first switch being connected to a first power supply;
a second switch, one end of the second switch being connected to a second terminal of the first capacitance, and another end of the second switch being connected to a second power supply;
a third switch, one end of the third switch being connected to the first terminal of the first capacitance, and another end of the third switch being connected to an output terminal;
an amplifier, an output of the amplifier being electrically connected to the second terminal of the first capacitance; and
a voltage-dividing resistor that generates a feedback voltage to be provided to the amplifier, the voltage-dividing resistor being connected to the first terminal of the first capacitance.

2. The DC/DC converter circuit according to claim 1, further comprising a fourth switch, one end of the fourth switch being connected to the second terminal of the first capacitance, and another end of the fourth switch being connected to the output of the amplifier.

3. The DC/DC converter circuit according to claim 1, wherein an operating state of the amplifier is switched by a control signal input to the amplifier.

4. The DC/DC converter circuit according to claim 1, further comprising a second capacitance connected in parallel with the boosting circuit.

5. The DC/DC converter circuit according to claim 1, wherein the DC/DC converter circuit is connected in parallel with another DC/DC converter circuit according to claim 1.
